(19) United States
(12) Patent Application Publication
(10) Pub. No.: US 2018/0374158 A1
(43) Pub. Date: Dec. 27, 2018

(54) SYSTEM AND METHOD FOR CREATING A BALANCED RETIREMENT CASH FLOW PLAN FOR A USER

(71) Applicant: PLYNTY, LLC, Herndon, VA (US)

(72) Inventors: Douglas Michael SCHNELZER, Ashburn, VA (US); Michael EDESESS, Kowloon (HK); Jeffrey Val RABOVSKY, Reston, VA (US); Tarryn Louise LEMMER, Reston, VA (US); Leah Anne HAMMOND, Fairfax, VA (US); Dirk Alvin ROPER, Carson City, NV (US); George Joseph PEACOCK, Washington, DC (US); Daniel Harris MARGOL, Washington, DC (US); Victoria VUONG, Fairfax, VA (US); Matthew Ramsey MORGAN, Marina Del Ray, CA (US); Madan BASTAKOTI, Manassas, VA (US); Sharon Mishler DEMONSABERT, Chantilly, VA (US); Dennis Jess HOOKS, Aldie, VA (US)

(73) Assignee: PLYNTY, LLC, Herndon, VA (US)

(21) Appl. No.: 16/120,505

(22) Filed: Sep. 4, 2018

Related U.S. Application Data
(63) Continuation of application No. 15/424,582, filed on Feb. 3, 2017, now abandoned.

(51) Int. Cl. G06Q 40/06; G06Q 40/00

(52) U.S. Cl. CPC G06Q 40/06; G06Q 40/10

(57) ABSTRACT

In an example implementation of an app downloadable on a computing device of a user, a method implemented by processing power of the device may enable the user to achieve a desired life event goal such as a balanced retirement cash flow plan. In the method, financial information is ingested from the user, and an average monthly retirement expense figure is estimated based on publicly available, actual expense information of like-kind individuals in a financial position similar to the user. An average monthly income figure is calculated in order for the user to achieve his or her life event goal, and a geometrical image representing both the calculated monthly income and estimated average monthly expenses figures is displayed on the computing device for review by the user.

### CROSS-REFERENCE TO RELATED APPLICATIONS

The present application claims the benefit under 35 U.S.C. § 120 and is a continuation of U.S. patent application Ser. No. 15/424,582 to Schnelzer, et al., filed Feb. 3, 2017, pending. The entire contents of each application is hereby incorporated by reference herein.

### BACKGROUND

### Field

Example embodiments in general relate to a computer system and computer-implemented method for creating a realistic balanced retirement cash flow plan for a user.

### Related Art

It is commonly known that Americans who plan for their future feel more confident. In the Mar. 19, 2016 article “9 Baby Boomer Retirement Facts That Will Knock Your Socks Off,” on the MOTLEY FOOL®, it was reported that, in 2015, nearly half of America's baby boomers determined their retirement savings by guesswork. Only 11% said they used a retirement calculator to plan their future finances. Thus, as reported in “Fact Sheet #3, Preparing for Retirement in America,” 2016 Retirement Confidence Survey, Employee Benefit Research Institute (EBRI) and Greenwald & Associates, it is no surprise that almost twice as many workers who have any sort of retirement plan feel more confident in their retirement planning (84 percent) than do workers without such a plan (44 percent).

Moreover, Americans are likely to live much longer than in years past. In an ABC NEWS® report “Older Americans Living Longer, Study Says,” on Aug. 10, 2016, it was revealed that there are approximately 35 million Americans aged 65 or older, accounting for 13% of the national population. In 1900, that age group was numbered at just 3.1 million. In “Why Retirement Planning is So Difficult,” by WHIO, published Nov. 4, 2016, it was stated that “compared to 50 years ago, the chances of a 65-year-old man reaching the age of 90 have more than doubled”. Given this, it is clear that retirement planning must account for these seminal changes. These needs are trying to be met on the web. With the advent of the Internet, financial services software has now become widely prevalent and accessible, and purport, as goals, to meet at least some of the above-noted challenges for the retiring American.

One conventional software package is available through Mint.com (“MINT®”). MINT, a wholly-owned subsidiary of INTUIT® Inc. According to their website, MINT's desktop and mobile device app products offer the following services to subscribers: (a) expense tracking and management; (b) money savings advice and tips; (c) an automated personal budget; and (d) a financial calculator with visual aids such as graphs and charts which purportedly reveals the subscriber's entire financial picture. In their Oct. 31, 2008 press release, MINT reported that subscribers indicated that they were reducing their monthly spending by 2% since January of that year, although MINT's own analysis alleged that subscribers shaved an average 4% from their spending, or $200 in just 30 days.

Another conventional software package is offered through HelloWallet.com (“HELLOWALLET™”). HELLOWALLET, owned by MORNINGSTAR® Inc., notes on their website that their mission is to “democratize access to independent financial guidance.” According to their web site, HELLOWALLET's desktop and mobile device app products purport to display a one-screenshot view of the subscriber's entire financial picture, including: (a) all recent financial transactions; (b) a wellness score; (c) a peer reference score; (d) an overview summary of current accounts and investments; (e) the subscriber's current monthly budget; (f) a snapshot of the budget plan for the subscriber; guidance priorities (such as healthcare), and (g) various messages and alerts. In its Sep. 14, 2011 press release, HELLOWALLET alleged that they “helped to increase average monthly savings contributions [of their subscribers] by over $300 (or nearly $4,000 annually)”.

Neither of the above planners are designed to help an individual maximize cash flow/income after retirement. Neither MINT nor HELLOWALLET use data of retired individuals to estimate a subscriber's expenses in retirement. Additionally, neither of these platforms use government survey data on retirees as part of preparing budgets and strategies that help an individual a person financially cope with retirement.

Thus, the retirement planning of today does not work for a lot of people. Financial planners can be hard to identify, cost a lot of money, and are often difficult to evaluate for the value they add. Online retirement calculators also leave a lot to be desired. They are too simple and still somehow too hard to understand. They show confusing graphs, set large sums of money as a target, and use rules of thumb to only indicate whether you are “on track.” It is hard for the user know what he or she is getting in retirement, and it's not clear what options he or she would have along the way to meet his or her goals.

Accordingly, there is a critical need to make retirement planning (as well as planning for other life events) simple and more effective. In satisfying this need, the user of the planning software needs to understand the information provided to him or her in both a written and graphical format that is easy to comprehend. Moreover, there is a need in the financial planning industry for a retirement planner that uses actual data of retired individuals to estimate a user's expenses in retirement, with data in part ingested from US. Bureau of Labor & Statistics (BLS) survey data on retirees as well as U.S. Social Security Administration (SSA) data on retirees as part of preparing budgets and strategies that help an individual financially cope with retirement.

### SUMMARY

An example embodiment of the presentation invention is directed to a computer-implemented method adapted to achieve a balanced retirement cash flow plan for a user. The method includes ingesting, by a computer, a current annual household pre-tax income value input by the user, and estimating, by the computer, a default monthly retirement expense budget for the user based in part on the ingested pre-tax income value. Estimating further includes, all as performed by the computer: determining a percentage of total aggregate expenditures by the user in retirement from a core dataset in a Bureau of Labor and Statistics (BLS) government consumer expenditure survey that has been collected for individuals at the user's ingested pre-tax income value, iterating a regression analysis using a data science tool to model the total aggregate expenditures to the income for a user in each given income bracket, whereby a least squares polynomial iterated by the data science tool fits pre-tax income to total aggregate expenditures to thereby create an equation that when given an income outputs the expected aggregate expenditure for that income, applying the user's ingested pre-tax income value to the created equation to output an expected aggregate expenditure for the user's ingested pre-tax income, and multiplying the expected aggregate expenditure by the percentage of total aggregate expenditure to output the estimated default initial monthly retirement expense budget. The method further includes calculating, by the computer, annual retirement income from non-retirement savings sources, based on additional inputs to the computer from the user upon one or more queries, calculating, by the computer, an annual ideal savings withdrawal from retirement savings in retirement, determining, by the computer as a function in part of the calculated ideal savings withdrawal from retirement savings, a score which indicates the actual amount of the annual ideal savings withdrawal a user can withdraw and still have retirement savings remaining to the end of their plan, and displaying, by the computer, a geometrical image for review by the user, the geometrical image including both a monthly value of the calculated annual retirement income from non-retirement savings sources, in connection with the estimated default monthly retirement expense budget value. Each of the ingesting, estimating, calculating annual retirement income from non-retirement savings sources, calculating the annual ideal savings withdrawal from retirement savings, and displaying steps are performed by computer software adapted to run on computer hardware.

### BRIEF DESCRIPTION OF THE DRAWINGS

Example embodiments will become more fully understood from the detailed description given herein below and the accompanying drawing, wherein like elements are represented by like reference numerals, which are given by way of illustration only and thus are not limitative of the example embodiments herein.

FIG. 1 is a flow diagram to illustrate a method for creating a balanced retirement cash flow plan for a user according to the exemplary embodiments.

FIG. 2 is a block diagram of a computer system for implementing the example method according to the example embodiments.

FIG. 3 is a block diagram illustrating an example client and server from the computer system of FIG. 1 according to certain aspects of the disclosure.

FIG. 4 is a flow diagram to illustrate the estimating of an initial, default retirement expense budget function of FIG. 1 in more detail.

FIG. 5 is a graph of linear earning curves from data collected for the BLS by the U.S. Census Bureau.

FIG. 6 is a graph that illustrates the regression of income to expenditure calculated using the NumPy data science tool.

FIG. 7 is a graph to illustrate the calculated & expended versus pre-tax income for each income bracket.

FIG. 8 is a screenshot of a pictorial representation for a user's projected retirement monthly cash flow budget determined in accordance with the example method.

### DETAILED DESCRIPTION

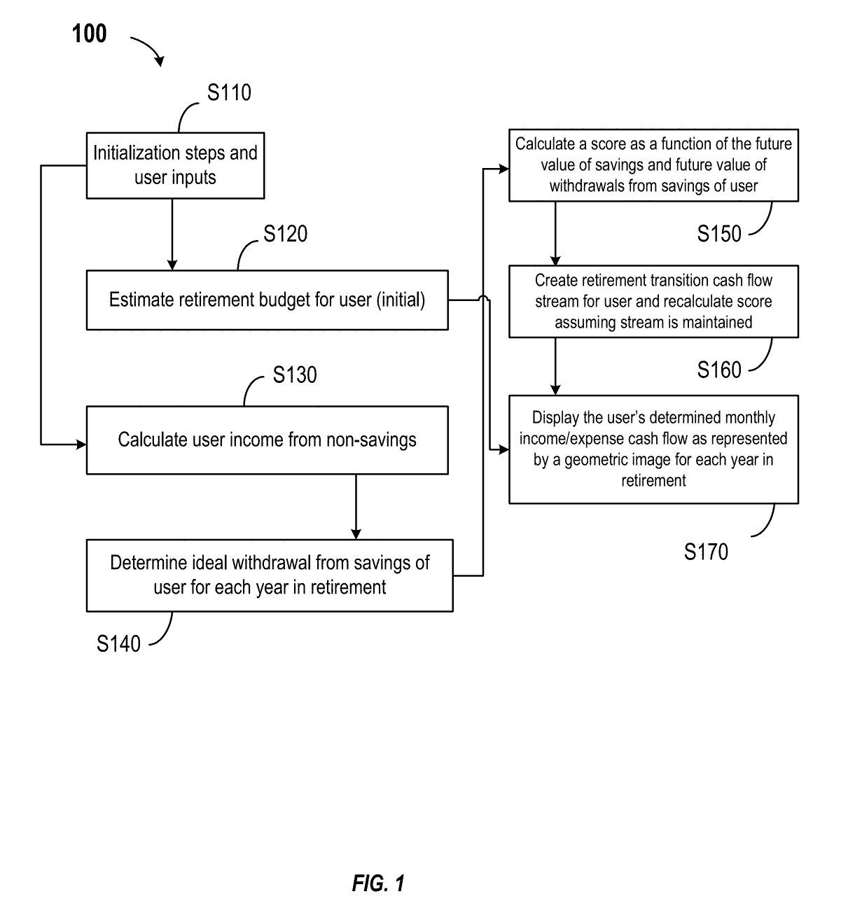

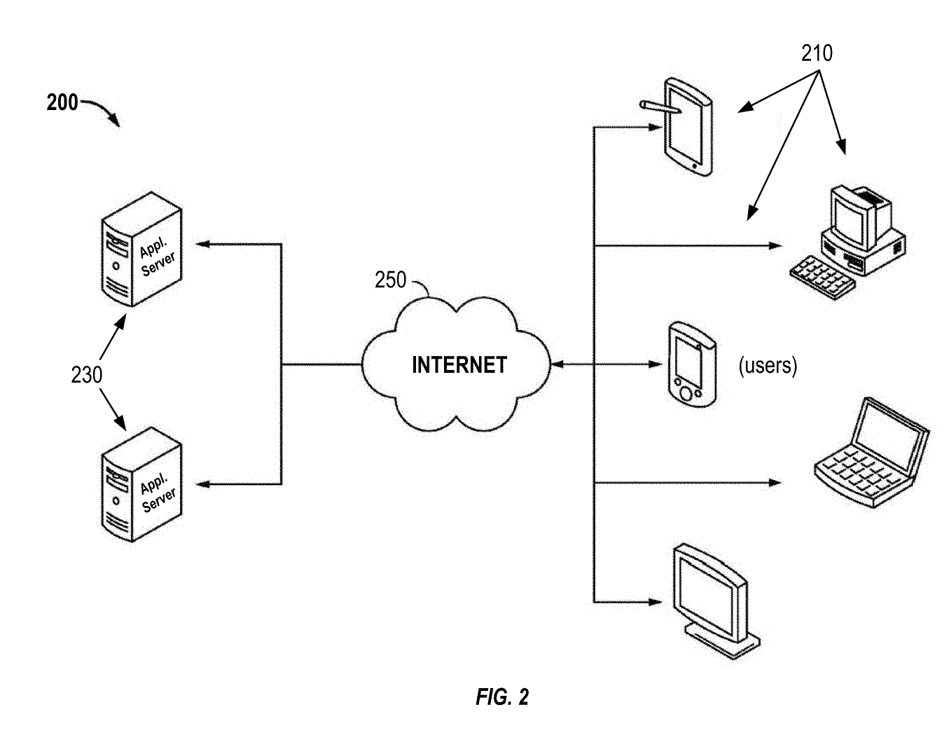

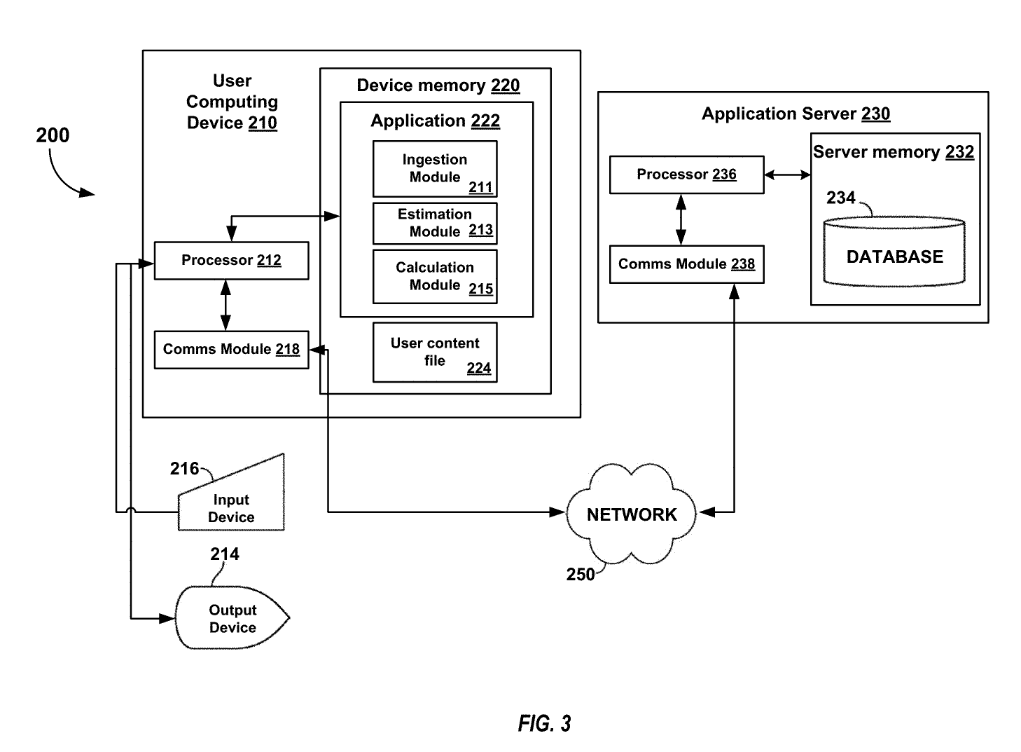

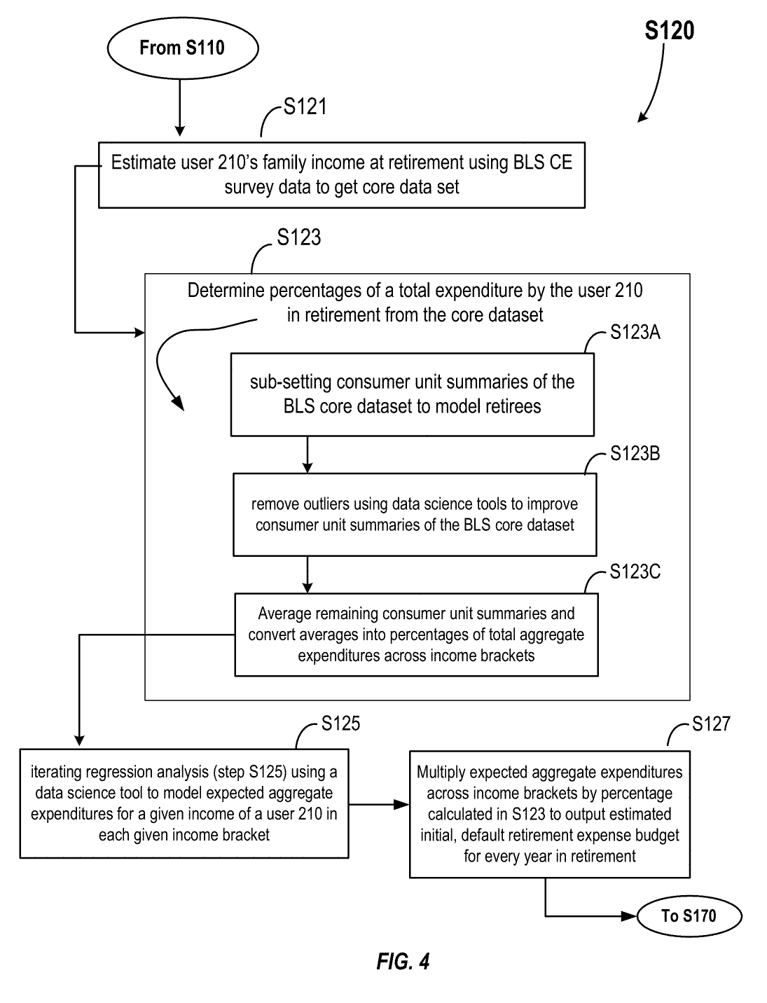

FIG. 1 is a flow diagram to illustrate a method for creating a balanced retirement cash flow plan for a user; FIG. 2 is a block diagram of an example computer system adapted to implement the method; FIG. 3 is a more detailed block diagram of the client/user server interface in computer system 200; and FIG. 4 is a flow diagram to illustrate the estimating function S120 of FIG. 1 in more detail. Referring to FIGS. 1 through 4, computer system 200 includes one or more application servers 230 and one or more client or user computing device(s) 210 (“user 210” for brevity) connected over a network, here shown as the internet 250. Internet 250 may be any network topology, including one or more of a personal area network (PAN), a local area network (LAN), a campus area network (CAN), a metropolitan area network (MAN), a wide area network (WAN), a broadband network (BBN), and the like.

At least one of the application servers 230 is configured to host a database (or portions thereof). The application servers 230 are configured to perform user 210 authentication, the storing of financial plans, and to interface with third-party providers to perform function including but not limited to financial account aggregation, information lookup (e.g., obtaining expense ratios for a user 210's mutual funds and his or her applications for insurance, etc.).

Application server(s) 230 can be any device having an appropriate processor, memory, and communications capability for hosting the database. The users 210 to which the servers 230 are connected over the internet 250 can be, for example, desktop computers, mobile computers, tablet computers (e.g., including e-book readers), mobile devices (e.g., smartphones or personal digital assistants), set top boxes (e.g., for a television), video game consoles, any other devices having appropriate processor, memory, and communications capabilities, and/or any computing device configured with a JAVASCRIPT engine, a processor and storage.

As shown in FIG. 3, the user 210 and the server 230 are connected over the internet 250 via respective communications modules 218 and 238. The communications modules 218 and 238 are configured to interface with the internet 250 to send and receive information, such as data, requests, responses, and commands to other devices on the network. The communications modules 218 and 238 can be, for example, CPUs with embedded WIFI or cellular network connectivity (one example CPU being the QUALCOMM® SNAPDRAGON™ 821 processor with X12 LTE), modems or Ethernet cards. The server 230 includes a processor 236, a communications module 238, and a memory 232 that includes a database 234.

The processor 236 of server 230 is configured to execute instructions, such as instructions physically coded into the processor 236, instructions received from software in memory 240, or a combination of both. A user 210 can enter a mode to select content or activate a function in a phone application 222 downloadable from the application server 230 via network 250, to be stored in memory for access by using a trigger, such as a long press on a touchscreen input device 216 or pressing the CTRL key and a mouse button on a keyboard and mouse. In certain aspects, a user 210 can automatically click on the application 222 once downloaded from the APPSTORE/PLAY STORE.

For example, content in a user content file 224 associated with the downloaded application 222 for display on the output device 214 of the user 210's computing device can be accessed using an input device 216 such as a touch screen or pointing device (e.g., a mouse). Alternatively, one or both of the input and output devices 214, 216 could be any of a CRT (cathode ray tube) LED (light emitting diode), or LCD (liquid crystal display) monitor for displaying information to the user 210, and include a keyboard and a pointing device, e.g., a mouse or a trackball, by which the user 210 can provide input to the computer system 200 (e.g., interact with a user interface element, for example, by clicking a button on such a pointing device). Other kinds of devices can be used to provide for interaction with a user 210 as well; for example, feedback provided to the user 210 can be any form of sensory feedback, e.g., visual feedback, auditory feedback, or tactile feedback; and input from the user 210 can be received in any form, including acoustic, speech, or tactile input.

Functions or outputs of the downloaded application 222 graphically shown on the output device 214 can be triggered by the user 210's finger where the input device 216 is a touch input, or with a cursor when the input device 216 is a mouse, or with the user's eyes when the input device 216 is an eye tracker. Alternatively, functions or outputs of the downloaded application 222 graphically shown on the display can be triggered based on the user 210's facial or physical expression when the input device 216 is a camera with appropriate gesture tracking technology, by the user's voice when the input device 216 is a microphone with appropriate voice recognition technology, or by the user's thoughts when the input device 216 is a brain-computer interface.

The exemplary method 100 of FIG. 1 may be described in the context of a typical use scenario. For this explanation, the user 210 is described in terms of a computing device embodied as a smart phone operated by a human being or artificial intelligence, and the commercial platform is embodied as the phone app 222 for download in memory on the user 210's smart phone. Based on online marketing around the commercial platform, a subscriber or customer (hereafter “user 210”) receives an e-mail message and investigates the platform's website, where the user 210 decides to try the mobile app, downloading it from a PLAY STORE/APPSTORE. Downloading may constitute the point of sale, where an initial monthly subscription is paid and the mobile app is downloaded.

Upon opening the app 222 via the input device 216, the user 210 is stepped through an onboarding or initialization process (step S110) where a private personal account is created and the user inputs pre-tax income information or other income information. Identifiable personal information is ingested as part of the onboarding process such as name, annual income, birthdate, and marital status. User credentials are stored in database 234 on the application servers 230, and credentials for the user 210's financial accounts (such as a VANGUARD® 401K account) are stored in databases of a reputable data service, such as QUOVO. The app 222 transmits, but does not persist, the user-provided login credentials to QUOVO. QUOVO retains end-user credentials of their financial accounts in order to provide the commercial platform with updates on end-user account information, as requested for the convenience of the users 210.

In no particular order, the user 210 will be queried to input sources of retirement income that is ingested by an ingestion module 211 within the app (step S120). An estimation module 213 in the app 222 concurrently estimates the user 210's retirement expenses (step S120) in order to determine an average monthly retirement expense figure for the user 210. As will be described in more detail hereafter, the retirement expenses estimated for the user 210 are based in part on the acquisition of publicly available, actual expense information of like-kind individuals in a financial position similar to the user 210.

The user 210 may input various income sources in retirement into the ingestion module 211 of app 222, such as a pension, his or her savings, and investments. User credentials to third-party customer accounts are accessed and aggregated by app 222 through a data service, one example being the QUOVO Data Service. The aggregation and storage of user 210 credentials is a generally accepted practice among many financial platforms, such as mint.com, personalcapital.com, levelmoney.com, and meetalbert.com, for example.

In order to aid the quick creation of a realistic financial plan, data services are used to prefill default financial inputs, such as housing costs and other typical retirement expenses, as well as typical Social Security benefits for the user 210's income bracket. This prefill data is ingested from selected data services, non-limiting examples including one or more of QUOVO®, QUOTE MEDIA®, CANNEX®, IE NETWORK®, RAFFA® INSURANCE, ZILLOW®, and the like, as well as data obtained from the Bureau of Labor and Statistics' (BLS).

In step S120, for each year in retirement, the app 222 first estimates the user 210's expense budget in today's dollars, unadjusted for inflation. This estimated expense budget is itemized by typical budgeting categories such as housing, living expenses, healthcare, travel and taxes. To accomplish this estimation, the estimation module 213 leverages extensive data science analysis of public information related to similarly situated (financially) people's retirement budgets. Data from the BLS, Consumer Expenditure Survey are core datasets used for this analysis.

In general, by ingesting data from lifetime earnings curves based on statistical data from the U.S. Social Security Administration (SSA), estimation module 213 estimates what the user 210's income will be at the time of retirement. Module 213 then applies the analysis from similar peoples' retirement expense budgets to generate a default expense budget for user 210. Having an initial default retirement expense budget is unique to the methodology behind app 222, and allows a user 210 thereof to quickly see how his or her likely retirement financial picture will look. The user 210 can customize the expense budget after he or she reviews the initial default values.

For each year in retirement, the example system 200 and method 100 estimates the user's retirement expense budget in today's dollars. As previously noted, the estimated initial, default retirement expense budget is broken down into typical categories such as housing, living expenses, healthcare, travel and taxes, etc. The process derives budget estimates from an extensive data science analysis of current retirees at a similar income.

Referring to FIG. 4, and to begin the retirement budget estimation process, the process estimates the user's family income at retirement (step S121). This is based in part on the current annual household pre-tax income value that is input by the user during initializing step S110. In doing so, the process uses linear approximations of lifetime earning curves taken from the Bureau of Labor Statistics Consumer Expenditure Survey (CE). The CE is a nationwide household survey conducted by the U.S. Bureau of Labor Statistics (BLS) to find out how Americans spend their money. It is the only federal government survey that provides information on the complete range of consumers' expenditures as well as their incomes and demographic characteristics. BLS publishes 12-month estimates of consumer expenditures twice a year with the estimates summarized by various income levels and household characteristics. BLS also produces annual public-use microdata files to help researchers analyze the data in more detail.

The CE consists of estimates derived from two separate surveys, known as the Interview Survey and the Diary Survey. The Quarterly Interview Survey is designed to collect data on large and recurring expenditures that consumers can be expected to recall for a period of 3 months or longer, such as rent and utilities, and the Diary Survey is designed to collect data on small, frequently purchased items, including most food and clothing. Together, the data from the two surveys cover the complete range of consumers' expenditures. CE data are collected for BLS by the U.S. Census Bureau.

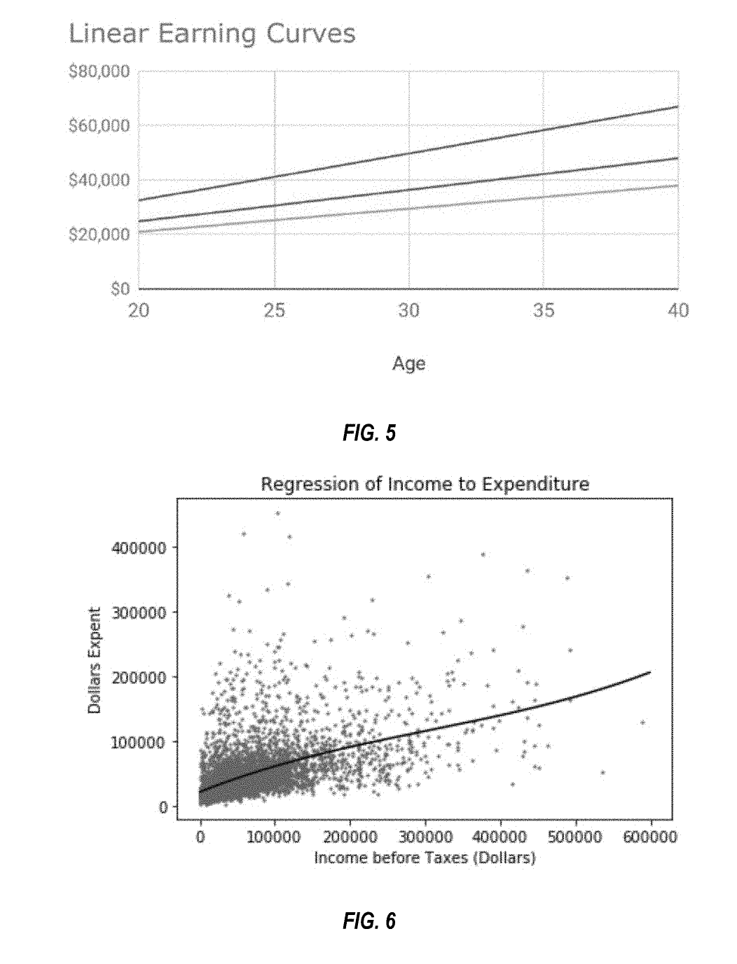

These earning curves (an example as shown in FIG. 5) are thus used in order to estimate typical raises. The user is matched to the closest linear approximation and the average monthly raise for that line to estimate the user's income at age 40. Earnings are assumed to be flat (in today's dollars) after the age of 40. This provides the user's estimated income for every year in retirement, to be further broken down to a monthly expense value. The outputs from these BLS curves represents a core dataset that has been collected for individuals at the user's income, the core data set being comprised of a plurality of consumer unit summaries.

Next, the retirement expense estimation process takes the estimated family income at retirement of user 210 calculated at step S121 and conducts an extensive data science analysis utilizing data from the Bureau of Labor and Statistics, Consumer Expenditure (CE) Survey to estimate an initial, default retirement budget. The estimated initial default retirement budget is broken down into ten (10) categories: housing, groceries, utilities, transportation, clothing, dining out, entertainment, charity, healthcare expenses, and other. This is determined for every year in retirement.

More particularly, and as part of the calculation or determination of the initial, default estimated retirement budget, one of the more innovative elements of the example process is in the data science employed behind the calculations for the estimated monthly retirement expense budget value. Namely, the estimating step S120 further includes determining percentages of a total expenditure (S123) by the user in retirement from the core dataset obtained in step S121. This determining step S123 further includes a step of sub-setting the consumer unit summaries of the BLS dataset to model retirees (sub-step S123A), and then improving the consumer unit summaries of the BLS dataset by removing outliers (sub-step S123B). These outliers are determined utilizing data science tools based on the Tukey Method which applies simultaneously to the set of all pairwise comparisons {ui-uj}, whereby a confidence coefficient for the core dataset, when all sample sizes are equal, is exactly 1-α, and is conservatively greater than 1-α for unequal sample sizes. The Tukey Method is further applied in order to determine an inner and outer fence, where values outside of the outer fence are considered outliers by method 100. For all of the consumer unit summaries that remain after outliers are removed, these are averaged and then the averages are converted into percentages of total aggregate expenditures (sub-step S123C) based on given income brackets.

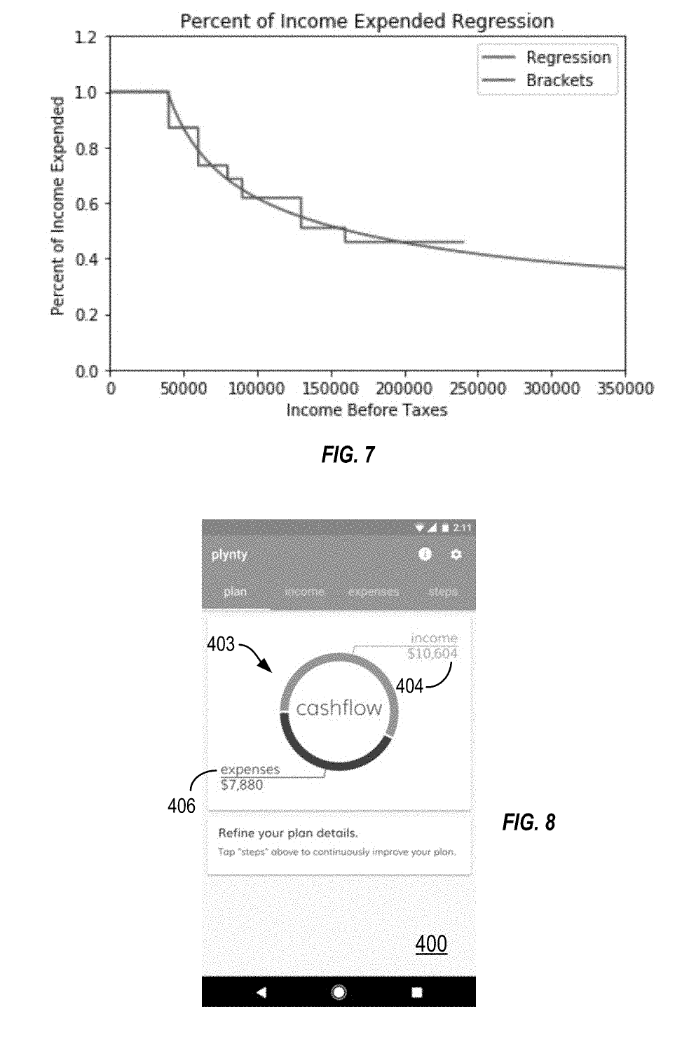

Next, step S120 includes iterating a regression analysis (step S125) using a data science tool to model the aggregate expenditures from step S123 to the income for a user in each given income bracket. Here, a least squares polynomial regression analysis iterated by the NumPy data science tool fits pre-tax income to total aggregate expenditures to thereby create an equation that, when given an income, outputs the expected aggregate expenditure for that income. FIG. 6 is a graph that illustrates the regression of income to expenditure calculated using the NumPy data science tool. FIG. 7 is a graph to illustrate the calculated & expended versus pre-tax income for each income bracket.

Next within step S120 includes applying the user's pre-tax income value to the created equation to output an expected aggregate expenditure for that income (step S125), and then at step S127 the expected aggregate expenditure form S125 is multiplied by the percentages of total expenditure calculated in S123 to output the estimated default initial retirement expense budget for every year in retirement, where each year is then divided by 12 to provide the estimated monthly expense budget in retirement.

The inventors submit that this determining of an initial, default estimated retirement budget based on the lifestyles of current retirees is unique the example method and permits a user 210 to envision their retirement financial lifestyle based on their current financial situation. The user 210 is presented with this initial default annual estimated expense budget to start their plan building, and they can then customize it throughout the retirement planning process.

Referring again to FIG. 1, and based on the user 210's input pre-tax income data and other income data ingested by ingestion module 211, a calculation module 215 of the app 222 calculates income from non-savings. To calculate how much savings is required to meet the projected budget, the step S130 initially determines retirement income from all other non-savings income sources. Non-savings retirement income sources include social security (taken from SSA databases), pensions, annuities and other sources. The financial planning engine (processor 212 and calculation module 215) imbued as part of the computer system which implements the process calculates the annual retirement income from each of the non-savings income sources, for each year in retirement.

Next, method 100 includes a step of calculating the user 210's ideal savings withdrawals in retirement (step S140). Here the calculation module 215 determines the user 210's ideal withdrawal from retirement savings (in each given year in retirement) by subtracting the income from non-savings sources as determined in step S130 for each given year, from the annual estimated initial, default retirement expense budget as determined in S120 for each year in retirement. The difference is the amount of income needed from retirement savings to fund 100% of the user 210's estimated retirement expense budget in that given year.

Further, in a next step method 100 calculates the percent of the user 210's projected actual savings to ideal savings, which is represented as a “score” (step S150). Here, calculation module 215 determines the percentage of savings that the user 210 at retirement will have, as compared to the ideal amount of savings they will need to cover their projected estimated initial, default retirement expense budget. This is effected by comparing the future value of the user 210's savings at the end of the retirement plan to the future value of ideal savings withdrawals at the end of retirement.

The resulting ratio represents the score, which the inventors refer to as a “plynty score”. This score indicates the percentage of needed savings a user 210 will have in retirement. For example, if a user 210's plynty score is 75%, then that user 210 at retirement can withdraw 75% of the ideal savings withdrawal for each year in retirement and have enough to last through the end of the retirement plan.

A follow on step is to add in a retirement cash flow (step S160). To address the risk of having retirement savings invested in market index funds, method 100 assumes that retirement savings income will be drawn from a retirement transition cash-equivalent account. The transition account is funded by withdrawing funds from the user 210's retirement savings five years before they are needed and placed in the cash-equivalent account.

Thereafter, the average monthly income and expenses in retirement may be displayed by an output device 214 to the screen of the user 210's smart phone within the app (step S170). FIG. 8 is a screenshot 400 of a pictorial representation for a user 210's projected retirement monthly cash flow budget determined in accordance with the example method 100.

A user 210's projected retirement monthly cash flow budget is presented throughout the app using a graphical or pictorial representation referred to as a “plynty donut”. This donut icon 403 or image displays the average monthly retirement income 404 (color-matched, as shown in green) over the average monthly retirement expenses 406 (color-matched in blue as shown). The donut icon 403 is in an easy-to-understand visual form of a retirement cash flow donut-shaped image, income over expense. The user 210 has the full capability to accept or change any of these pre-filled values.

Once the user 210 has completed creation of his or her plan, including income sources, expenses and the chosen retirement date, his or her future situation may be continually revised and analyzed as a monthly cash flow beginning on the day he or she retires until he or she dies, which, consistent with today's financial planning best practices, is assumed to be 95 years old. As customers use the app 222, they are offered tips on how to best create their plan, offered opportunities to consider the implications of changes to key variables such as retirement age and their investment portfolios, and offered annuity, reverse mortgage, and term life insurance products based upon their individual circumstances and needs.

The elegance of the data science and its use to determine an estimated retirement budget, and the code and processing developed in order to determine the “plynty score” that represents a percentage of the user's ideal savings withdrawals at which a user as a retiree can withdraw for each year in retirement and have enough to last through the end of the retirement plan, each by its own right presents significant improvements in computer-related technology. The computer-related improvements within method 100 described herein as implemented by computer system 200 enable iteration of the functions described in FIGS. 1 and 4 to 8 which, based on a user's input of financial information and the user's desired goal of reaching or completing a given, future life event (such as retirement), coupled with an evaluation of data of other actual U.S. consumers taken from federal consumer surveys (consumers who have a similar financial profile as that of the user), recommends investment and financial planning options to build a plan for the user that attains the goal or achieves the desired life event.

Moreover, the inventive method 100, in addition to making use of and leveraging the latest in data science tools, offers recommendations and strategies of SEC-registered investment advisors in order to provide the user with investment and financial planning advice services. In addition to registered investment and financial planning advice and activities geared toward the retiree, the inventive method 100 further provides advice in non-registered activities such as lifelong cash flow calculations and life insurance planning and fulfillment.

We claim:

1. A computer-implemented method adapted to achieve a balanced retirement cash flow plan for a user, comprising:
ingesting, by a computer, a current annual household pre-tax income value input by the user,
estimating, by the computer, a default monthly retirement expense budget for the user based in part on the ingested pre-tax income value, the calculating step further including, all as performed by the computer:
determining a percentage of total aggregate expenditures by the user in retirement from a core dataset in a Bureau of Labor and Statistics (BLS) government consumer expenditure survey that has been collected for individuals at the user's ingested pre-tax income value,
iterating a regression analysis using a data science tool to model the total aggregate expenditures to the income for a user in each given income bracket, whereby a least squares polynomial iterated by the data science tool fits pre-tax income to total aggregate expenditures to thereby create an equation that when given an income outputs the expected aggregate expenditure for that income,
applying the user's ingested pre-tax income value to the created equation to output an expected aggregate expenditure for the user's ingested pre-tax income, and
multiplying the expected aggregate expenditure by the percentage of total aggregate expenditure to output the estimated default initial monthly retirement expense budget,
calculating, by the computer, annual retirement income from non-retirement savings sources, based on additional inputs to the computer from the user upon one or more queries,
calculating, by the computer, an annual ideal savings withdrawal from retirement savings in retirement,
determining, by the computer as a function in part of the calculated ideal savings withdrawal from retirement savings, a score which indicates the actual amount of the annual ideal savings withdrawal a user can withdraw and still have retirement savings remaining to the end of their plan, and
displaying, by the computer, a geometrical image for review by the user, the geometrical image including both a monthly value of the calculated annual retirement income from non-retirement savings sources, in connection with the estimated default monthly retirement expense budget value,
wherein the ingesting, estimating, calculating annual retirement income from non-retirement savings sources, calculating the annual ideal savings withdrawal from retirement savings, and displaying steps are performed by computer software adapted to run on computer hardware.
